(19) United States
(12) Patent Application Publication
(10) Pub. No.: US 2006/0028073 A1
(43) Pub. Date: Feb. 9, 2006

(54) Electromagnetic operation device

(76) Inventors: Tomohiro Sugino, Hitachi (JP); Ayumu Morita, Hitachi (JP); Kenji Tsuchiya, Hitachi (JP); Masato Kobayashi, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/180,553

(22) Filed: Jul. 14, 2005

(30) Foreign Application Priority Data
Jul. 23, 2004 (JP) 2004-215789

(51) Int. Cl. H02K 37/14

(52) U.S. Cl. 310/49 R

(57) ABSTRACT

An electromagnetic operation device, comprising electromagnetic operators each paired with a vacuum valve of each phase of three phases, is equipped with main shafts that can operate independently for each phase and a three-phase connecting shaft that synchronizes the operation of the three phases in accordance with the operation of each main shaft. The rod of the electromagnetic operator is connected with the blade of the main shaft at the fulcrum and the blade of the three-phase connecting shaft is connected with the blade of the main shaft by the linkage. The motion of a main shaft that has operated quicker than the others is transmitted to the other main shafts via the three-phase connecting shaft so as to synchronize the operation of the three phases.

### CLAIM OF PRIORITY

The present application claims priority from Japanese application serial no. 2004-215789, filed on Jul. 23, 2004, the content of which is hereby incorporated by reference into this application.

### FIELD OF THE INVENTION

The present invention relates to an electromagnetic operation device, particularly to the electromagnetic operation device that is suitable for switching a switch such as circuit breaker with the aid of electromagnetic force.

### BACKGROUND OF THE INVENTION

To operate a switch such as circuit breaker, an electromagnetic operator that switches with the aid of electromagnetic force generated by electromagnet is utilized (see Japanese Patent Laid-open No. 2002-217026).

There is also available a hybrid type operator on which electromagnetic suction force of electromagnet is used to turn on the switch and permanent magnet is employed to keep the switch on (see Japanese Patent Laid-open No. 2001-216875).

### SUMMARY OF THE INVENTION

When the above electromagnetic operator is used for vacuum valve in a three-phase power system, the electromagnetic operator is usually paired one-to-one with vacuum valve of each phase by a main shaft, but lag may be caused in the operation of the electromagnetic operator because of the variation of each phase. Consequently, there arises a problem that the shut-off timing of vacuum valve of each phase varies and so stable shut-off of the power system cannot be achieved.

In addition, the size of the electromagnetic operator and its controller has become larger as electromagnet has become larger, which resultantly disables space saving.

In view of the above problems associated with the prior art, an object of the present invention is to offer an electromagnetic operation device that can absorb variation of each phase. Another object is to offer an electromagnetic operation device that encloses its own parts and components efficiently.

To achieve the above objects, the present invention is an electromagnetic operation device comprises a main shaft that can operate for each phase and a connecting shaft that synchronizes the operation of the main shafts of three phases.

According to the present invention, even in case the main shaft connected with the vacuum valve of each phase operates differently and one of the main shafts operates quicker than the others, lag of each phase can be absorbed and so the vacuum valve can be shut off stably because the electromagnetic operation device is equipped with a three-phase connecting shaft that enables the other main shafts to follow the quicker main shaft.

### BRIEF DESCRIPTION OF DRAWINGS

FIG. 1 shows a plan view of the electromagnetic operation device according to the first embodiment and vacuum valve.

FIG. 2 shows a front view of the electromagnetic operation device according to the first embodiment.

FIG. 3A shows a side view of the arrangement in the OFF state in the first embodiment.

FIG. 3B shows a side view of the arrangement in the ON state in the first embodiment.

FIG. 4 is a brief figure showing the arrangement and connection of the main shafts and three-phase connecting shaft.

FIG. 5 shows a front view of the electromagnetic operation device according to the second embodiment.

FIG. 6 shows a side view of the electromagnetic operation device according to the second embodiment.

FIG. 7 shows a side view of the electromagnetic operation device according to the third embodiment.

### DESCRIPTION OF THE PREFERRED EMBODIMENTS

Embodiments of the present invention are described hereunder, using figures. In the figures, the same symbol represents the same component.

(First Embodiment)

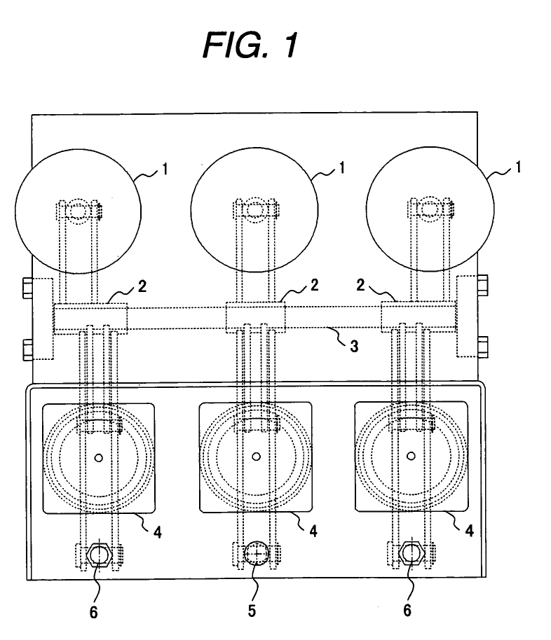

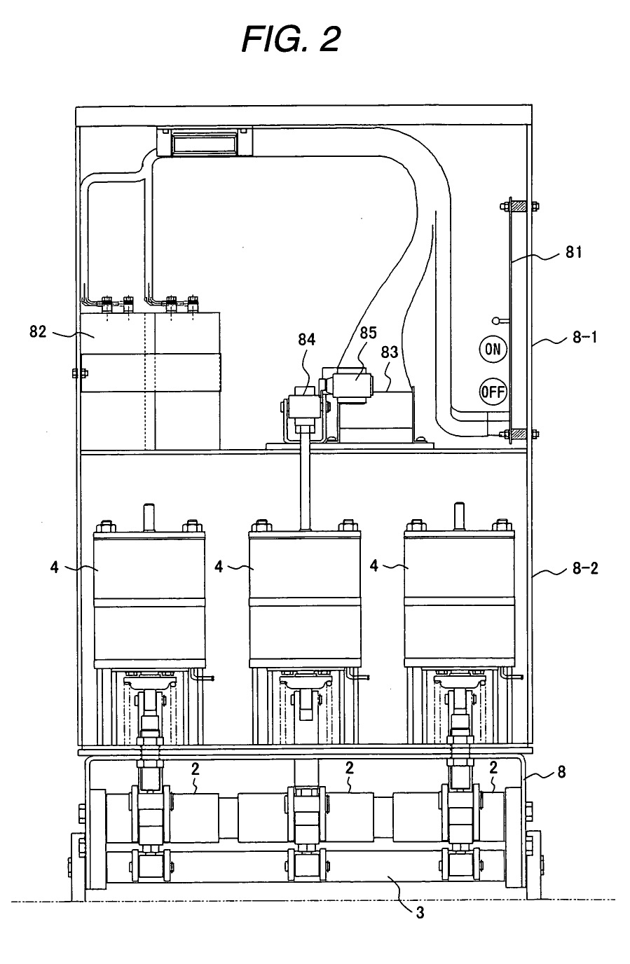

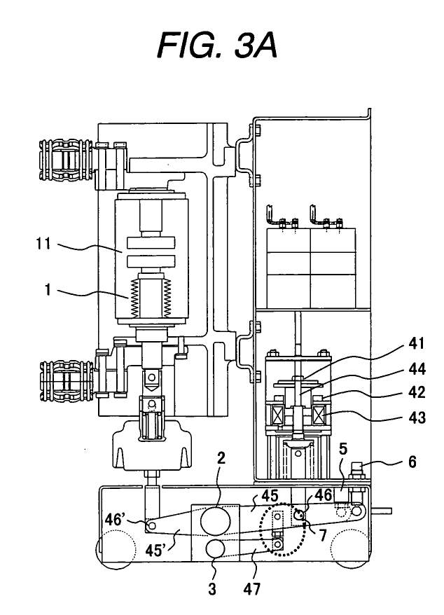

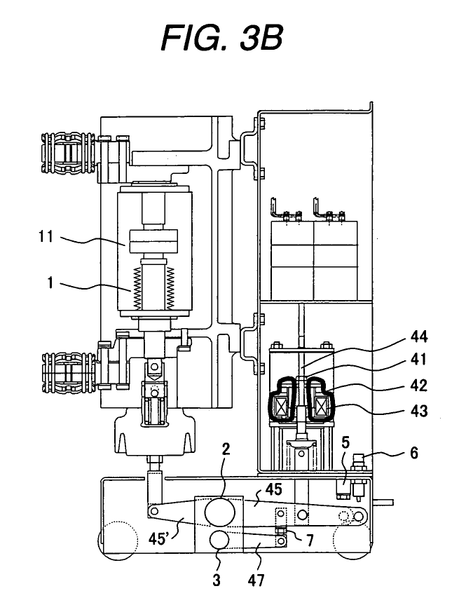

FIG. 1 is a plan view of the electromagnetic operation device of the present invention; FIG. 2 is a front view including electromagnetic operators and controller; FIGS. 3A and 3B are side view including the main shafts and three-phase connecting shaft.

As shown in FIG. 1, the vacuum valve 1 of each phase is connected with the electromagnetic operator 4 via the main shaft 2. Each main shaft 2 starts operation freely from other phases, but is connected with others by the three-phase connecting shaft 2 for synchronization.

As shown in FIG. 2, the electromagnetic operation device is enclosed in a multi-stage box case 8, where controller including a control board 81 and capacitor 82 are enclosed in the upper stage 8-1 and an electromagnetic operator 4 is enclosed in the middle stage 8-2. The upper stage 8-1 can not only be provided above the center electromagnetic operator 4 as shown in the figure but also be provided above other electromagnetic operators 4.

The control board 81 contains a control logic section that receives a signal of turn-on command (ON) or shut-off command (OFF) to the vacuum valve 1 and performs logical operation for controlling the electromagnetic operator 4, charging/discharging circuit for charging and discharging the capacitor 82, relay for controlling the current direction through a coil 43, and contacts. In addition, there are provided an “ON” pushbutton for sending a turn-on command to the vacuum valve 1 and an “OFF” pushbutton for sending a shut-off command. A mechanism for detecting the condition of vacuum valve 1, comprising an auxiliary contact 83, display panel 84 and counter 85, is mounted above the electromagnetic operator 4.

As explained above, the auxiliary contact section (counter 85, display panel 84, and auxiliary contact 83) of the controller is mounted above the center electromagnetic operator 4 and so designed to operate in line with the electromagnetic operator 4. In addition, since the control board 81, capacitor 82, and auxiliary contact section are enclosed in a separate box from the electromagnetic operators, affect of big impact can be reduced. Furthermore, separate wiring for the auxiliary contact section becomes possible and parts replacement of the section becomes easier.

FIG. 3A shows the OFF state of the vacuum valve 1. The electromagnetic operator 4 is equipped with a moving core 41, permanent magnet 42 and coil 43. When the controller is turned on the coil 43 is energized, the moving core 41 moves downward together with the rod 44. Since the lower end of the rod 44 is connected with the blade 45 at the fulcrum 46, motion of the rod 44 is transmitted to the main shaft 2. Since the main shaft 2 is connected with the operation rod 12 of the vacuum valve 1 via the blade 45′ provided on the other side of the blade 45, the turn-on operation of the electromagnetic operator 4 is transmitted to the vacuum valve 1 and so the valve contact 11 goes ON.

FIG. 3B shows the ON state of the vacuum valve 1. The ON state of the vacuum valve 1 can be kept by the retention force of the permanent magnet 42 as the flux of the permanent magnet 42 flows as shown in a bold line in the figure.

On the other hand, when a reverse current runs through the coil 43 upon the shut-off operation of the controller, since the flux generated by the coil 43 becomes opposite to that of the permanent magnet 42 and so the suction force of the moving core 41 becomes less than the elastic force of a spring (not shown), the moving core 41 moves upward. Accordingly, a reverse operation to the above is performed via the main shaft 2 that connects the vacuum valve one-to-one with the electromagnetic operator 4, and the valve contact 11 goes OFF.

When one vacuum valve 1 is paired with one electromagnetic operator 4, variation in the operation of the electromagnetic operator 4 causes lag in the turn-on and shut-off timing of the vacuum valve 1 of each phase. To prevent this, a three-phase connecting shaft 3 is provided below each main shaft 2 and each main shaft 2 is connected with the three-phase connecting shaft 3 via the linkage 7.

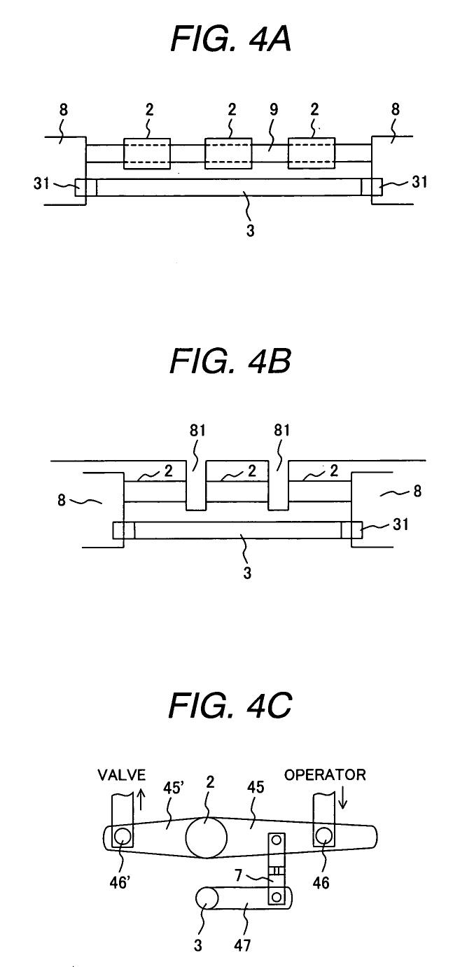

FIG. 4 is a conceptual figure of the arrangement and connection of the main shafts 2 and three-phase connecting shaft 3. FIG. 4(a) is a front view. A bar 9 placed above the case 8 supports each main shaft 2 so as to ensure rotation, below which a solid lubricant 31 holds the three-phase connecting shaft 3. FIG. 4(b) shows the main shaft 2 supported in a different manner, where a partition 81 formed on the case 8 is provided between each phase and each main shaft 2 is supported by the partition 81.

FIG. 4(c) is a side view, showing the connection between the main shaft 2 and three-phase connecting shaft 3. Because of this connection, in case of variation in the turn-on or shut-off operation, the motion of the main shaft 2 of a phase that has operated quicker than the others is transmitted to the connecting shaft 3 and the three-phase connecting shaft 3 so operates as to hasten the operation of the main shaft 2 of slow phases. To speak from an opposite viewpoint, the main shaft 2 of slowly operating phase restricts the motion of the main shaft 2 of quickly operating phase.

According to the above embodiment, since the contacting time lag of the valve contact 11 due to the variation in the operation of the electromagnetic operator 4 of each phase can be reduced and the operation of the three phases can be synchronized by the three-phase connecting shaft 3 connecting each electromagnetic operator 4, stable turn-on and shut-off operation of the power system becomes available. In addition, in case of using multiple electromagnetic operators, imbalanced load to the shaft due to the variation in the operation of electromagnetic operators 4 can be reduced because a main shaft 2 that enables independent operation of each phase is employed.

In shutting off the vacuum valve 1, it is necessary to absorb impact applied to the main shaft 2 upon the shut-off and stop the motion of the valve quickly. As shown in FIG. 1 and FIG. 3A, of the three-phase electromagnetic operators 4 in this embodiment, the center electromagnetic operator 4 is provided with a stopper 5 and the other electromagnetic operators 4 are each provided with a shock absorber 6.

In the construction in FIG. 1, since the center main shaft 2 deflects more than the other two main shafts 2, quick absorption cannot be expected if an impact is first given to the center. Accordingly, the impact is absorbed by the shock absorber 6 on both sides first of all, and then the motion is stopped by the center stopper 5 installed at a limit position.

According to this embodiment, impact can be absorbed quickly and well in balance by the shock absorbers 6 on both sides where no deflection is caused, and by dispersing a force like the above, smaller shock absorber becomes applicable.

(Second Embodiment)

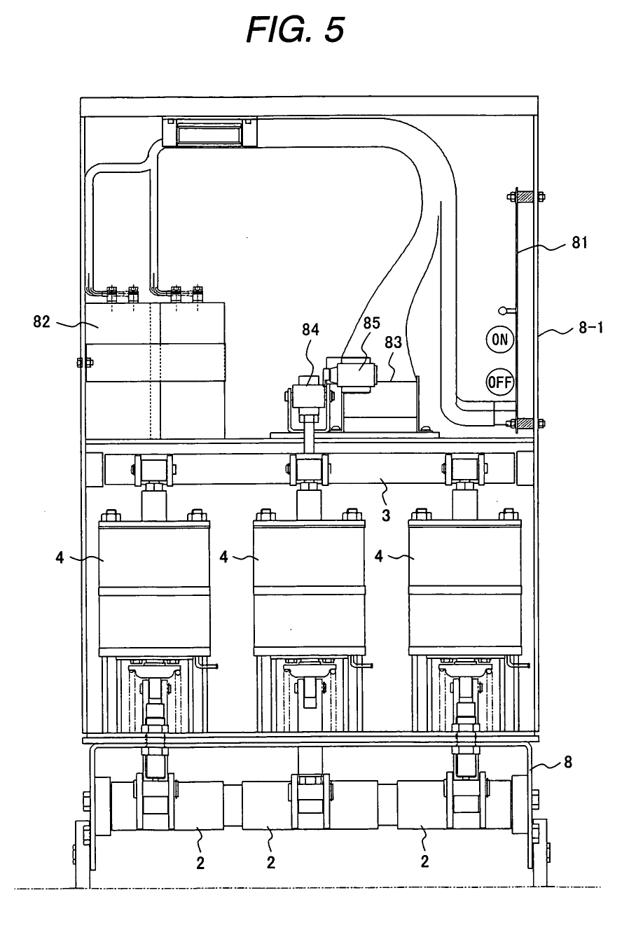

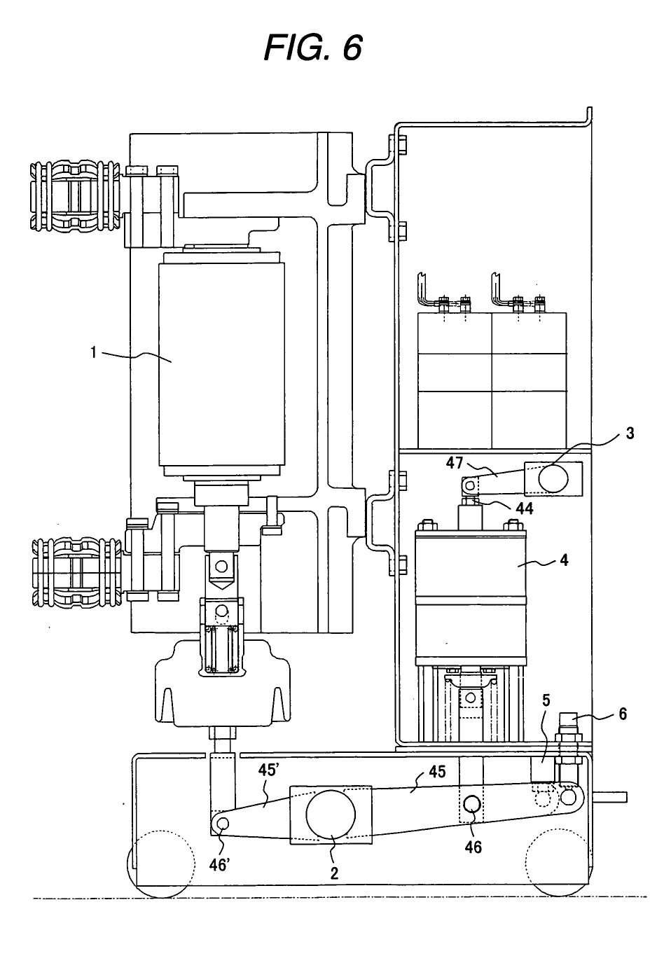

Next, the second embodiment of the present invention is described hereunder. FIG. 5 and FIG. 6 show an embodiment where the three-phase connecting shaft 3 is provided above the electromagnetic operator 4.

The three-phase connecting shaft 3 is provided above the electromagnetic operator 4 and the main shaft 2 is provided below the electromagnetic operator 4. The two shafts are connected via the rod 44 of the electromagnetic operator 4. That is to say, because the rod 44 is connected with the blade 45 of the main shaft 2 at the fulcrum 46, the motion of the rod 44 is transmitted to the blade 47 of the three-phase connecting shaft 3. Accordingly, the three-phase connecting shaft 3 can synchronize the operation of the main shafts 3 of each phase.

(Third Embodiment)

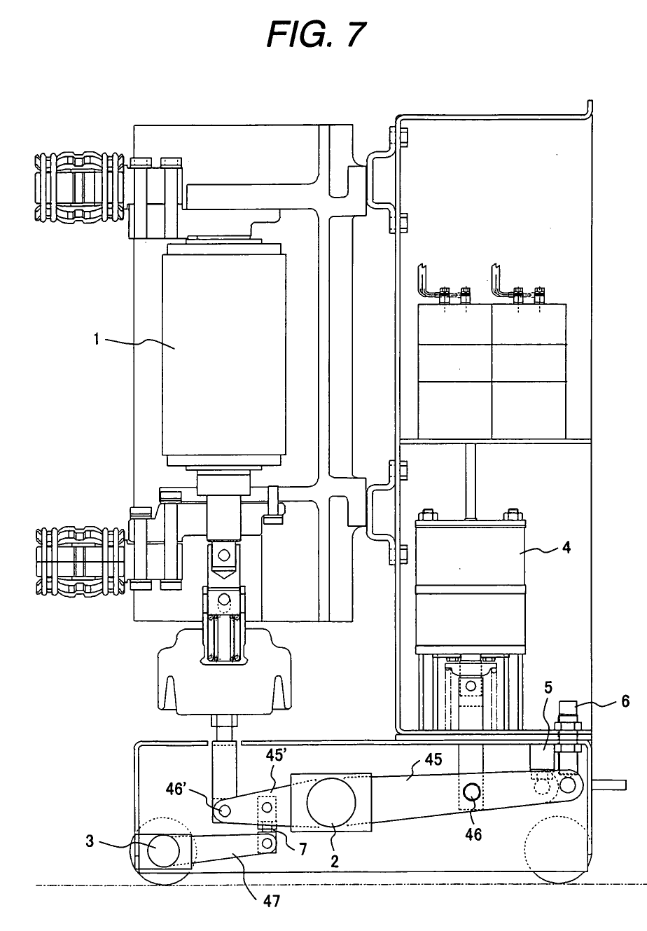

Next, the third embodiment of the present invention is described hereunder. FIG. 7 shows an embodiment where the three-phase connecting shaft 3 is provided on the vacuum valve 1 side. This differs from the first embodiment in a point that the three-phase connecting shaft 3 is provided on the vacuum valve 1 side below the main shaft 2. The linkage 7 is provided between the blade 45′ on the vacuum valve 1 side of the main shaft and blade 47 of the three-phase connecting shaft. Linkage operation is the same as in the fist embodiment.

While any of the three embodiments described above shall be selected in accordance with the arrangement of the electromagnetic operation device, the first and third embodiments allow easier installation and adjustment because the main shafts and three-phase connecting shafts are provided in the same portion of the case. On the other hand, the second embodiment is advantageous in case space is available above the electromagnetic operator because a linkage for connecting two blades with each other is no longer necessary.

What is claimed is:

1. An electromagnetic operation device, comprising three vacuum valves for three phases and three electromagnetic operators paired with said vacuum valves, wherein further comprising:
three main shafts that can operate independently for each phase; and
a three-phase connecting shaft for synchronizing the operation of said three main shafts in accordance with the operation of each main shaft.

2. The electromagnetic operation device according to claim 1, wherein respective said three main shafts are provided below respective said three electromagnetic operators and said three-phase connecting shaft is provided below said three main shafts so that the motion of any one of the main shafts is transmitted to the other main shaft via said three-phase connecting shaft.

3. The electromagnetic operation device according to claim 1, wherein respective said three main shafts are provided below respective said three electromagnetic operators and said three-phase connecting shaft is provided above said three electromagnetic operators so that the motion of any one of the main shafts is transmitted to the other main shaft via said three-phase connecting shaft.

4. The electromagnetic operation device according to claim 3, wherein said three main shafts are connected with said three-phase connecting shaft via the rods of said three electromagnetic operators.

5. The electromagnetic operation device according to claim 1, wherein respective said three main shafts are provided below respective said three electromagnetic operators and said three-phase connecting shaft is provided below said vacuum valves so that the motion of any one of the main shafts is transmitted to the other main shaft via said three-phase connecting shaft.

6. The electromagnetic operation device according to claim 5, wherein said three main shafts are connected with said three-phase connecting shaft via the blades on the vacuum valve side of the main shafts.

7. The electromagnetic operation device according to claim 1, wherein controller of said three electromagnetic operator, including control board, capacitor and auxiliary contact, is enclosed in a separate box that is separated from a box enclosing said three electromagnetic operators.

8. The electromagnetic operation device according to claim 7, wherein said separate box enclosing said controller is so constructed as to be replaceable separately from said electromagnetic operators.

9. The electromagnetic operation device according to claim 1, wherein, of said three electromagnetic operators, the center electromagnetic operator is provided with a stopper and the other electromagnetic operators are each provided with a shock absorber.
